(19) United States
(12) Patent Application Publication
(10) Pub. No.: US 2025/0349097 A1
(43) Pub. Date: Nov. 13, 2025

(54) PROCESSING DEVICE, PROCESSING SYSTEM, AND PROCESSING METHOD

(71) Applicant: FANUC CORPORATION, Minamitsuru-gun, Yamanashi (JP)

(72) Inventor: Yuusuke OOTA, Minamitsuru-gun, Yamanashi (JP)

(73) Assignee: FANUC CORPORATION, Minamitsuru-gun, Yamanashi (JP)

(21) Appl. No.: 18/871,368

(22) PCT Filed: Jun. 22, 2022
(86) PCT No.: PCT/JP2022/024969

§ 371 Date: Dec. 3, 2024

(51) Int. Cl. G06T 19/20

(52) U.S. Cl. CPC G06T 19/20; G06T 2219/2004; G06T 2219/2012; G06T 2219/2016

(57) ABSTRACT

A processing device including a measurement point cloud display unit that three-dimensionally displays a point cloud including an object on a screen, a region model display unit that three-dimensionally displays a region model on the screen, a positioning unit that positions the region model by changing the position and the posture of the region model and thereby sets the point cloud of the object so as to be at least partially surrounded by the region model, and a setting unit that sets a region which is within the screen and is surrounded by the positioned region model as the model of the object.

### CROSS REFERENCE TO RELATED APPLICATIONS

This is the U.S. National Phase application of PCT/JP2022/024969, filed Jun. 22, 2022, the disclosure of this application being incorporated herein by reference in its entirety for all purposes.

### FIELD OF THE INVENTION

The present invention relates to a processing device, a processing system, and a processing method.

### BACKGROUND OF THE INVENTION

The use of a 3D camera to detect a target workpiece and determine the position and posture of the workpiece is common practice. To detect the workpiece, it is necessary to teach the processing device performing the detection process a workpiece model and the reference position and posture of a workpiece in advance.

One method for teaching a model is to set the model based on a point cloud of the workpiece obtained from an image captured by a camera (for example, Japanese Unexamined Patent Publication (Kokai) No. 2021-062416).

### PATENT LITERATURE

PTL1: Japanese Unexamined Patent Publication (Kokai) No. 2021-062416

### SUMMARY OF THE INVENTION

However, creating a model based on a point cloud of a workpiece requires complex calculations, which is cumbersome.

Thus, there is a demand for a technology with which a workpiece model can easily be created based on a point cloud of a workpiece.

According to a first aspect of the present disclosure, there is provided a processing device, comprising a screen, a measurement point cloud display unit for displaying in 3D a point cloud including a target measured by a 3D camera on the screen, an area model display unit for displaying in 3D an area model on the screen, a positioning unit for changing a position and posture of the area model displayed by the area model display unit to position the area model such that the point cloud of the target is at least partially surrounded by the area model, and a setting unit for setting an area in the screen surrounded by the area model positioned by the positioning unit as a model of the target.

There is further provided a processing system comprising the processing device of the first aspect and the 3D camera.

There is further provided a processing method, comprising the steps of displaying in 3D a point cloud including a target measured by a 3D camera on a screen, displaying in 3D an area model on the screen, changing a position and posture of the area model to position the area model such that the point cloud of the target is at least partially surrounded by the area model, and setting an area in the screen surrounded by the positioned area model as a model of the target.

The object, features, and advantages of the present invention will become more apparent from the following detailed description of the embodiments in conjunction with the accompanying drawings.

### BRIEF DESCRIPTION OF THE DRAWINGS

FIG. 1 is a schematic view of a system comprising a processing device of a first embodiment of the present invention.

FIG. 2 is a block diagram of the system comprising the processing device of the first embodiment of the present invention.

FIG. 3 is a flowchart showing the operations of the processing device of the first embodiment of the present invention.

FIG. 4A is a view showing a point cloud of a workpiece of the first embodiment.

FIG. 4B is a view showing a point cloud of a workpiece and an area model of the first embodiment.

FIG. 5A is a schematic view of an area model.

FIG. 5B is a view showing an overall enlargement of the area model shown in FIG. 5A.

FIG. 5C is a view showing the area model shown in FIG. 5A in which the posture is changed.

FIG. 5D is a view showing a partial enlargement of the area model shown in FIG. 5A.

FIG. 6A is a view showing another area model.

FIG. 6B is a view showing yet another area model.

FIG. 6C is a view showing a menu screen for selecting an area model.

FIG. 7A is a view showing another workpiece.

FIG. 7B is a view showing yet another workpiece.

FIG. 8 is a view showing an additional area model of a second embodiment.

FIG. 9A is a view showing an area model of a third embodiment.

FIG. 9B is a view showing the workpiece shown in FIG. 9A, etc.

FIG. 10 is a flowchart showing the operations of a processing device of the third embodiment of the present invention.

### DETAILED DESCRIPTION OF EMBODIMENTS OF THE INVENTION

The embodiments of the present invention will be described below with reference to the attached drawings. In the drawings, corresponding constituent elements have been assigned common reference signs.

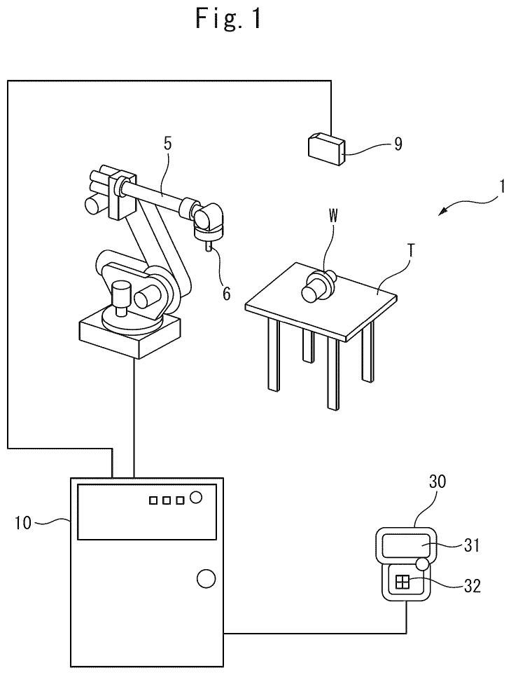

FIG. 1 is a schematic view of a system comprising a processing device of a first embodiment of the present invention. As shown in FIG. 1, the system 1 primarily includes a robot 5 comprising an end effector 6, for example, an articulated robot, a 3D camera 9, and a teach pendant 30 comprising an input unit 32. A workpiece W as a target is arranged on a table T arranged near the robot 5. The workpiece W has a three-dimensional shape. For example, the workpiece W shown in FIG. 1 has a shape consisting of a central disk portion and a shaft portion penetrating the disk portion. The disk portion and the shaft portion may be integrally formed. The shape of the workpiece W is not limited to this.

FIG. 1 shows a configuration in which the end effector 6 of the robot 5 grips or machines the workpiece W. Note that a configuration having a three-dimensional scanner may be used in place of the 3D camera 9.

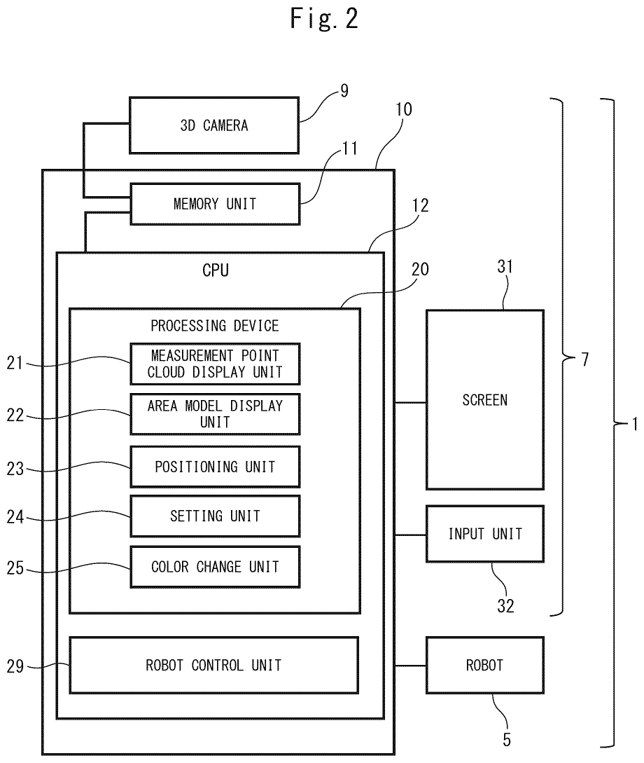

FIG. 2 is a block diagram of the system comprising the processing device according to the first embodiment of the present invention. A controller 10 of the system 1 is a computer, and includes a memory unit 11, such as ROM or RAM, a CPU (Central Processing Unit) 12, and buses connecting the memory unit 11 and the CPU 12. The memory unit 11 stores images captured by the 3D camera 9, as well as the operation program for the robot 5, an area model M (described later), and various parameters.

Though the input unit 32 is a part of the teach pendant 30 in FIG. 1, the input unit 32 may be an external device, for example, a keyboard, a mouse, or a touch panel. The screen 31 may be a part of the teach pendant 30, or may be an independent screen 31 such as a CRT or a liquid crystal monitor. The configuration including the 3D camera 9, the memory unit 11, the processing device 20, the screen 31, and the input unit 32 is referred to as a processing system 7.

The CPU 12 serves as a robot control unit 29 for controlling the processing device 20 and the robot 5, which will be described in detail later. The processing device 20 comprises a measurement point cloud display unit 21 for displaying in 3D a point cloud including the target (workpiece) W in a three-dimensional image captured by the 3D camera 9 on the screen 31, and an area model display unit 22 for displaying in 3D an area model M on the screen 31. The processing device 20 further comprises a positioning unit 23 for changing the position and posture of the area model M displayed by the area model display unit 22 to position the area model M so that the point cloud of the target W is at least partially surrounded by the area model M, and a setting unit 24 for setting an area in the screen 31 surrounded by the area model M positioned by the positioning unit 23 as a model of the target W. The processing device 20 further comprises a color change unit 25 for changing the color of at least one of the point cloud of the target W and the area model M in response to an input operation from the input unit 32.

The measurement point cloud display unit 21, area model display unit 22, positioning unit 23, setting unit 24, and color change unit 25 are, for example, functional modules realized by a computer program executed on the processor 12. The computer program for executing the processes of the measurement point cloud display unit 21 to color change unit 25 possessed by the processor 12 may be provided in a form recorded on a computer-readable recording medium such as a semiconductor memory, a magnetic recording medium, or an optical recording medium.

Note that the processing device 20 or the robot control unit 29 may have an imaging control function for the 3D camera 9, a setting function for the model M, MW and detection parameters (score threshold and reference position of the workpiece), a screen display function for teaching operation in which the model M, MW are taught to the robot 5, and a workpiece detection function using the taught model M, MW.

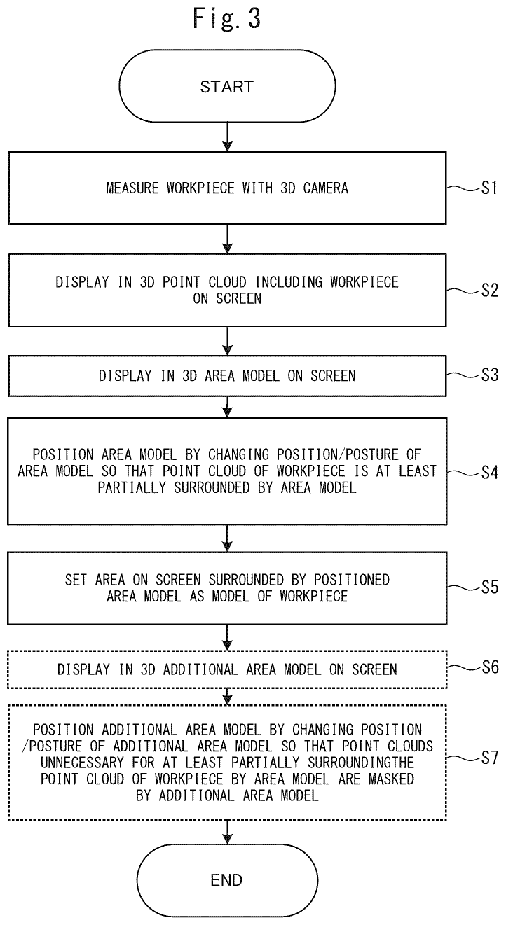

FIG. 3 is a flowchart showing the operation of the processing device of the first embodiment of the present invention. The contents shown in FIG. 3 are stored in advance in the memory unit 11 of the operation program of the processing device.

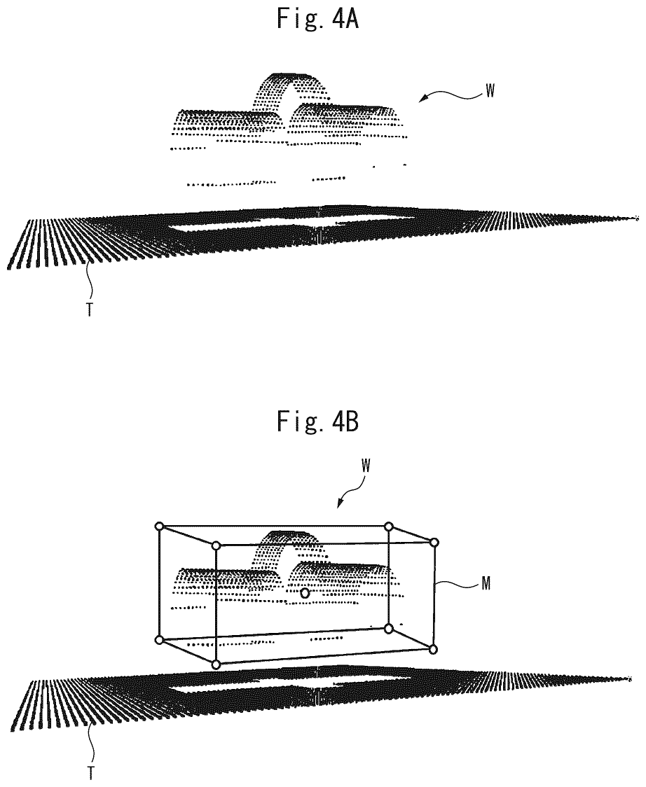

First, in step S1, the 3D camera 9 captures an image of the workpiece W arranged on the table T. The three-dimensional image of the workpiece W is stored in the memory unit 11. Next, in step S2, the measurement point cloud display unit 21 displays the three-dimensional image including the point cloud of the workpiece W on the screen 31. FIG. 4A is a view showing the point cloud of the workpiece of the first embodiment. In FIG. 4A, the point cloud of the workpiece W is arranged on the point cloud of the table T.

Next, in step S3, the area model display unit 22 displays in 3D the area model M on the screen 31 in response to an operation by the operator. FIG. 4B is a view showing the point cloud and area model of the workpiece of the first embodiment. The area model M shown in FIG. 4B is a three-dimensionally displayed rectangular parallelepiped frame. As will be described later, the area model M may have other shapes, such as a spherical or a capsule-like shape.

The initial values of the position and posture of the area model M and the initial values of the size may be arbitrary values determined in accordance with the installation location and size of the workpiece W. Alternatively, the area model display unit 22 may calculate the initial values of the position and posture of the area model M and the initial values of the size so that all point clouds measured from the 3D camera are included in the area model M, and then display the area model M on the screen 31. The case in which the area model M is a rectangular parallelepiped will be described below.

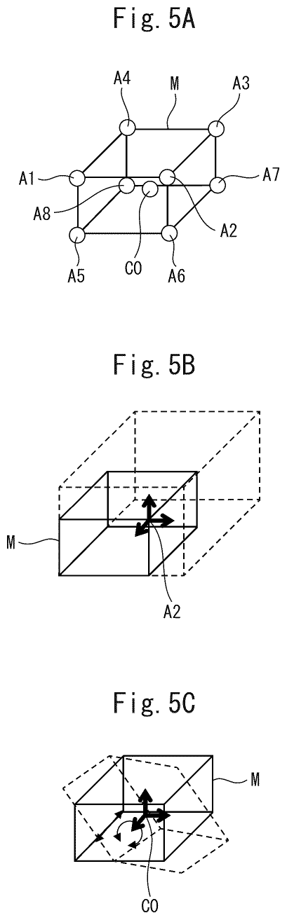

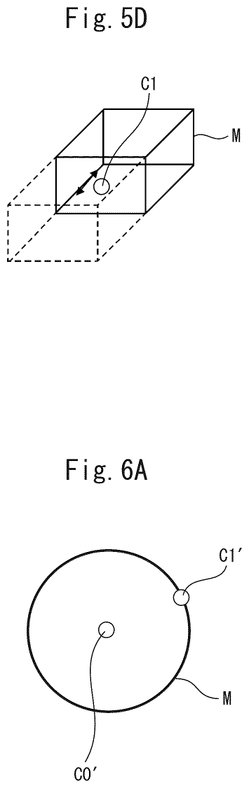

FIG. 5A is a schematic view of an area model. In FIG. 5A, each vertex A1 to A8 of the area model M and the center CO of the area model M are highlighted with white circles. These white circles are referred to as operation points. For the purpose of simplicity, the operation points may be omitted from the illustrations.

Next, in step S4, the operator operates the input unit 32 to position the area model M so that the point cloud of the workpiece W is at least partially surrounded by the area model M. This operation is performed via the positioning unit 23.

FIGS. 5B to 5D are views showing the area model shown in FIG. 5A. For example, in FIG. 5B, the operator operates the input unit 32 to perform a drag operation in the diagonal direction of one surface of the area model M while keeping the operation point A2 specified. This changes the position of the vertex A2, thereby enlarging the area model M as a whole. It is also possible to shrink the area model M by a similar operation.

In FIG. 5C, the operator operates the input unit 32 to translate or rotate the operation point C0 by dragging while keeping the operation point C0 specified. This allows the area model to translate or the area model M to rotate around the center C0 in accordance with the dragging operation.

Regarding the operation point C0, when the operation point C0 is specified, a menu regarding whether to translate or rotate the area model M may be displayed on the screen 31. Likewise, when the vertex A2 is specified, a similar menu screen regarding whether to enlarge, shrink, or rotate the area model M may be displayed on the screen 31. Alternatively, when one of the arrows indicating the XYZ directions shown in FIG. 5C is specified, the area model M may be rotated about the specified direction. In this manner, the operation regarding the area model M may be changed depending on the specified position of the area model M.

In FIG. 5D, an operation point C1 is arranged on the center of one surface of the area model M. The operator operates the input unit 32 to drag the operation point C1 in the depth direction of the area model M (the normal direction of the surface on which the operation point C1 is arranged) while keeping the operation point C1 specified. This allows the area model M to be partially enlarged/reduced.

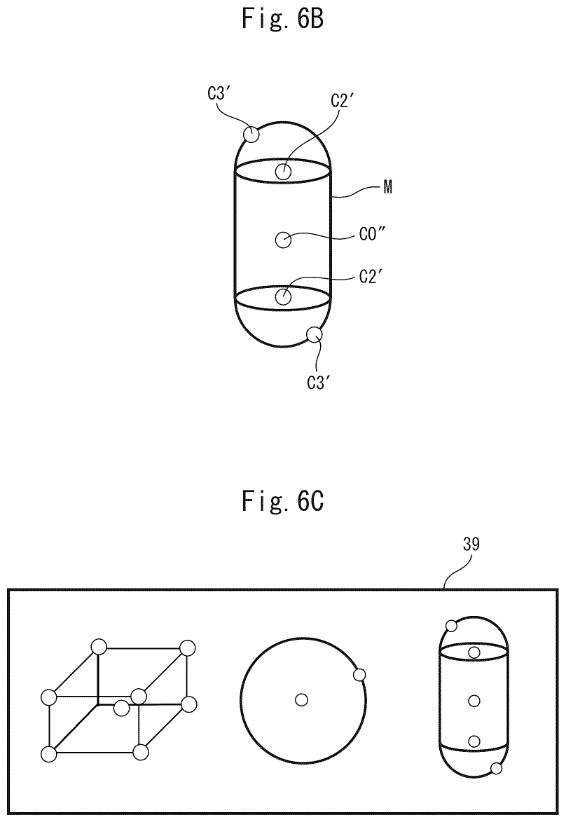

Note that when the area model M has another shape, for example, a sphere, as shown in FIG. 6A, the position of the area model M can be changed by manipulating the operation point CO′ located at the center of the sphere, and the area model M can be enlarged or reduced by manipulating the operation point C1′ located on the edge of the sphere in the same manner as described above.

Alternatively, as shown in FIG. 6B, when the area model M is capsule-like (a combination of a cylinder and two hemispheres each connected to an end face of the cylinder), the position and posture can be changed by manipulating an operation point C0″ located in the center of the cylinder, and the area model M can be enlarged or reduced by manipulating an operation point C2′ located in the center of the end face of the cylinder or an operation point C3′ located on the edge of the hemisphere in the same manner as described above.

FIG. 6C is a view showing a menu screen for selecting an area model. The menu screen 39 shown in FIG. 6C may be displayed on the screen 31 between steps S2 and S3 of FIG. 3. The operator may use the input unit 32 to select an area model M of a desired shape. As a result, the operator can select an area model M that is optimal for the shape of the workpiece W, whereby the operation described below can be performed more accurately.

The numerical values related to the position and posture of the area model M and the numerical values related to the size of the area model M may be separately displayed on the screen 31. Furthermore, the operator may directly input the numerical values related to the position and posture of the area model M and the numerical values related to the size of the area model M using the input unit 32, thereby changing the position and posture and size of the area model M.

Via the operations shown in FIGS. 5B to 5D, the operator positions the area model M so that the point cloud of the workpiece W is at least partially surrounded by the area model M. As a result, as shown in FIG. 4B, the point cloud of the workpiece W is at least partially surrounded by the area model M. It is preferable that the point cloud of the workpiece W be completely surrounded by the area model M. It is preferable also that the area model M be the minimum size that at least partially surrounds the workpiece W.

Next, in step S5, the area within the screen 31 surrounded by the positioned area model M is set as the model MW of the workpiece W. Thus, in the present invention, a simplified model MW can be easily created based on the point cloud of the workpiece W.

Next, the position and posture of the workpiece W is taught to the robot 5 by a known method based on the model MW. The robot 5 is then operated in accordance with the operation program for the robot 5 based on the taught position and posture of the workpiece W. Alternatively, the workpiece W may be detected using the model MW in another image captured by the 3D camera 9.

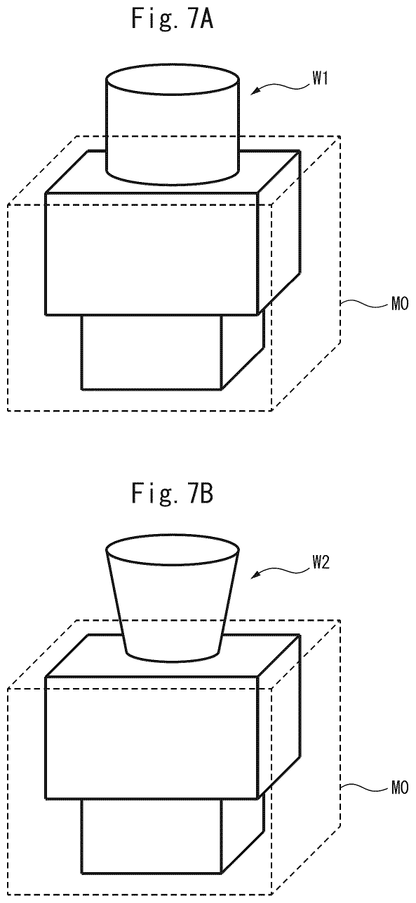

FIGS. 7A and 7B are views showing other workpieces. The workpiece W1 shown in FIG. 7A has a shape in which a large rectangular parallelepiped is arranged between a cylinder and a small rectangular parallelepiped. In contrast, the workpiece W2 shown in FIG. 7B has a shape in which a large rectangular parallelepiped is arranged between a truncated cone and a small rectangular parallelepiped. Specifically, the workpiece W1 and the workpiece W2 have a common portion consisting of a small rectangular parallelepiped and a large rectangular parallelepiped.

In such a case, as shown in FIGS. 7A and 7B, only the common part of the workpieces W1 and W2 is surrounded by the area model M0. Specifically, the workpieces W1 and W2 are only partially surrounded by the area model M0. In this case, the model MW0 of the workpiece W can be set with the common area model M0 for the different workpieces W1 and W2. In other words, in another image in which a large number of workpieces W1 and W2 are captured, the model MW0 of the workpieces W1 and W2 can be set using the common model MW0. Alternatively, the different workpieces W1 and W2 may be detected using the common model MW0 for yet another image captured by the 3D camera 9.

Note that the color change unit 25 not only changes the color of at least one of the area model M and the point cloud of the target W, but may also change the type of line constituting the area model M, such as a solid line, a dashed line, or a dash-dot line, in response to the operation of the input unit 32.

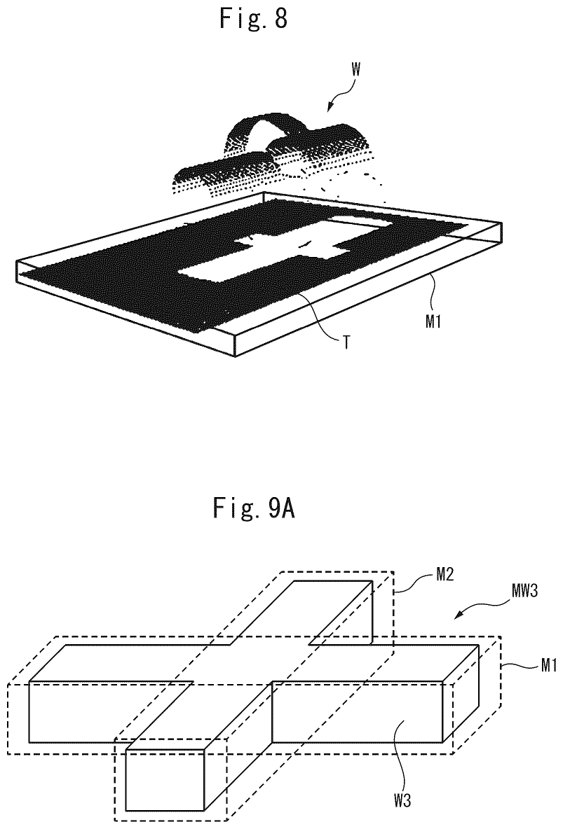

In a second embodiment of the present invention, the same processes S1 to S5 as those in the first embodiment are performed. In the second embodiment, the additional area model M′ is displayed in 3D on the screen in step S6 of FIG. 3. In step S7, the position and posture of the additional area model M′ is changed to position the additional area model M′. FIG. 8 is a view showing the additional area model in the second embodiment. In FIG. 8, the additional area model M′ is positioned so as to at least partially surround the point cloud of the table T. Note that in FIG. 8, the area model M for the workpiece W is omitted from the illustration for the purpose of simplification.

The point cloud of the table T shown in FIG. 8 is a point cloud that is unnecessary for at least partially surrounding the point cloud of the workpiece W by the area model M. In the second embodiment, such point cloud of the table T is surrounded by an additional area model M′, and the region surrounded by the additional area model M′ is then masked.

By masking point clouds unrelated to the workpiece W, such as the table T and background, with the additional area model M′ in this manner, it becomes easier to set the model of the workpiece W. Note that steps S6 and S7 may be performed first to surround unnecessary point clouds with the area model M′, and then steps S1 to S5 may be performed to create the model WM of the workpiece W. It can be understood that this makes it easier and more accurate to create the model WM of the workpiece W. Note that a plurality of area models M′ may be used to perform mask processing for a plurality of locations.

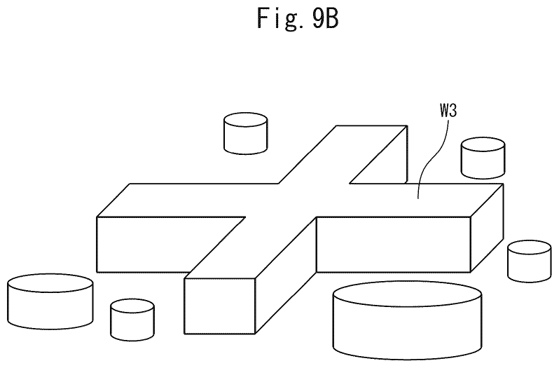

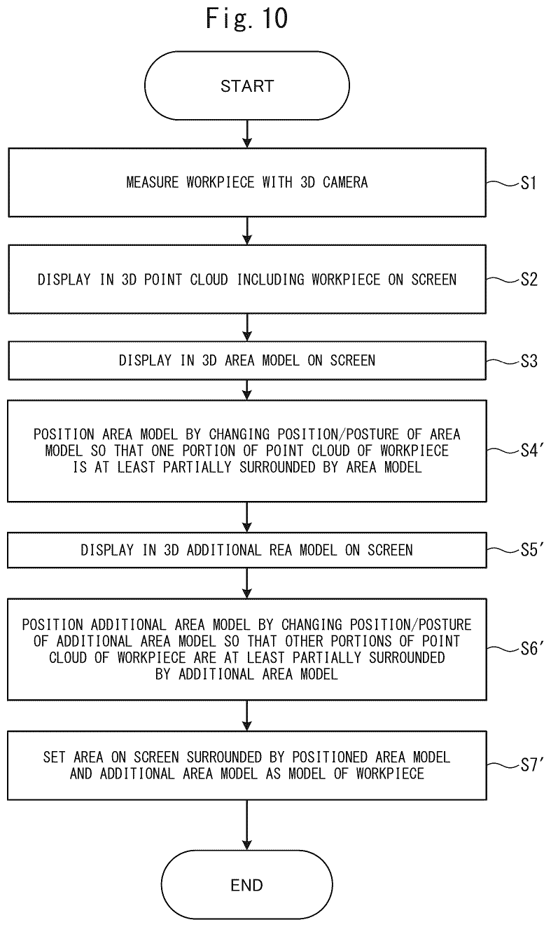

Furthermore, FIG. 9A is a view showing an area model, etc., of a third embodiment, and FIG. 9B is a view showing the workpiece shown in FIG. 9A, etc. Furthermore, FIG. 10 is a flowchart showing the operation of a processing device of the third embodiment of the present invention. Since steps S1 to S3 of FIG. 10 are the same as those described above, repeated descriptions thereof have been omitted.

The workpiece W3 shown in FIG. 9A is a substantially X-shaped workpiece consisting of two elongated parts. When setting such a workpiece W3 as a model, first, in step S4′, the position and posture of the area model M1 is changed to position the area model M1 so that a part of the workpiece W3, for example, one of the elongated parts, is at least partially surrounded.

Next, in step S5′, the additional area model M2 is displayed on the screen 31. Then, in step S6′, the position and posture of the area model M2 is changed to position the area model M2 so that another portion of the workpiece W3, for example, the other elongated portion, is at least partially surrounded.

Finally, in step S7′, the area in the screen 31 surrounded by the positioned area model M1 and the additional area model M2 is set as the model MW3 of the workpiece W3. Naturally, two or more area models may be used to surround the workpiece W. As a result, it is easy to set the model MW3 of the workpiece W3 even if it has a complex shape.

As can be understood from FIG. 9B, the image captured by the 3D camera 9 may contain foreign objects other than the workpiece. As described above, even if foreign objects are present around the workpiece W3, the process described with reference to FIG. 10 can be used to surround the workpiece W3 with the area models M1 and M2 so that the foreign objects are not included, thereby allowing the model MW3 to be set accurately. Thus, the third embodiment is advantageous for setting a workpiece model having a complex shape.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

### REFERENCE SIGNS LIST

1 system
5 robot
7 processing system
10 controller
11 memory unit
20 processing device
21 measurement point cloud display unit
22 area model display unit
23 positioning unit
24 setting unit
25 color change unit
30 teach pendant
31 screen
32 input unit
39 menu screen
M, M′, M0, M1, M2 area model
MW, MW0, MW3 workpiece model
W, W1, W2, W3 workpiece

1. A processing device, comprising:
a screen,
a measurement point cloud display unit for displaying in 3D a point cloud including a target measured by a 3D camera on the screen,
an area model display unit for displaying in 3D an area model on the screen,
a positioning unit for changing a position and posture of the area model displayed by the area model display unit to position the area model such that the point cloud of the target is at least partially surrounded by the area model, and
a setting unit for setting an area in the screen surrounded by the area model positioned by the positioning unit as a model of the target.

2. The processing device according to claim 1, wherein the area model is a rectangular parallelepiped, a sphere, or a capsule.

3. The processing device according to claim 2, wherein the area model has at least one of an operation point for changing a size of the area model and an operation point for changing a position and posture of the area model.

4. The processing device according to claim 1, comprising an input unit for inputting a position, posture, and size of the area model.

5. The processing device according to claim 1, comprising a color change unit for changing a color of at least one of the point cloud of the target and the area model.

6. The processing device of claim 1, wherein the area model display unit displays an additional area model in 3D on the screen, and
the positioning unit changes a position and posture of the additional area model displayed by the area model display unit to position the additional area model such that point clouds unnecessary for at least partially surrounding the point cloud of the target by the area model are masked by the additional area model.

7. The processing device of claim 1, wherein the area model display unit displays an additional area model in 3D on the screen, and
the positioning unit changes a position and posture of the additional area model displayed by the area model display unit to position the additional area model such that the point cloud of the target is at least partially surrounded by the area model and the additional area model.

8. A processing system, comprising:
the processing device according to claim 1, and
the 3D camera.

9. A processing method, comprising the steps of:
displaying in 3D a point cloud including a target measured by a 3D camera on a screen,
displaying in 3D an area model on the screen,
changing a position and posture of the area model to position the area model such that the point cloud of the target is at least partially surrounded by the area model, and
setting an area in the screen surrounded by the positioned area model as a model of the target.

10. The processing method according to claim 9, further comprising displaying an additional area model on the screen in 3D, and
changing a position and posture of the additional area model to position the additional area model such that point clouds unnecessary for at least partially surrounding the point cloud of the target by the area model are masked by the additional area model.

11. The processing method according to claim 9, further comprising displaying an additional area model on the screen in 3D, and
changing a position and posture of the additional area model to position the additional area model such that the point cloud of the target is at least partially surrounded by the area model and the additional area model.
